(19) United States
(12) Patent Application Publication
(10) Pub. No.: US 2020/0394568 A1
(43) Pub. Date: Dec. 17, 2020

(54) ROOM BOOKING EFFICIENCY AND USAGE ALLOWANCE

(71) Applicant: International Business Machines Corporation, Armonk, NY (US)

(72) Inventors: Prach Jerry Chuaypradit, Apex, NC (US); Schayne Bellrose, Wappingers Falls, NY (US); Pasquale A. Catalano, Wallkill, NY (US); Christopher John Hutton, Hurley, NY (US)

(21) Appl. No.: 16/439,841

(22) Filed: Jun. 13, 2019

(51) Int. Cl. G06Q 10/02; G06Q 10/10

(52) U.S. Cl. CPC G06Q 10/02; G06Q 10/1095

(57) ABSTRACT

A booking request is received for a room. Booking efficiency data for a user associated with the booking request is retrieved. Based on the booking efficiency data and a set of room attributes for the room, the booking request is determined to fail a restriction criterion. In response to failing the restriction criterion, a predicted demand threshold for the room is determined to not be met. The room is booked for the user, according to the booking request.

### BACKGROUND

The present disclosure relates generally to the field of room booking, and more particularly to conference room booking efficiency and usage allowance.

Rooms may be booked for a variety of reasons, such as conferences, presentations, meetings, study, accommodation, recreation, etc. Traditional techniques for room booking may include a first-come-first-served style of booking.

### SUMMARY

Embodiments of the present disclosure include a method, computer program product, and system for room booking.

A booking request is received for a room. Booking efficiency data for a user associated with the booking request is retrieved. Based on the booking efficiency data and a set of room attributes for the room, the booking request is determined to fail a restriction criterion. In response to failing the restriction criterion, a predicted demand threshold for the room is determined to not be met. The room is booked for the user, according to the booking request.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a diagram of a conference room equipped with various sensors, in accordance with embodiments of the present disclosure.

FIG. 2 illustrates an example networking environment, in accordance with embodiments of the present disclosure.

FIG. 3 illustrates a flowchart of a method for collecting room data, in accordance with embodiments of the present disclosure.

FIG. 4 illustrates a flowchart of a method for room booking efficiency and usage allowance in accordance with embodiments of the present disclosure.

FIG. 5 depicts a cloud computing environment according to an embodiment of the present disclosure.

FIG. 6 depicts abstraction model layers according to an embodiment of the present disclosure.

FIG. 7 illustrates a high-level block diagram of an example computer system that may be used in implementing embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of room booking, and more particularly to conference room booking efficiency and usage allowance. While the present disclosure is not necessarily limited to such applications, various aspects of the disclosure may be appreciated through a discussion of various examples using this context.

Traditional techniques for room booking are typically limited to a first-come-first-served style, where an individual simply reserves a room for a particular time period. For example, an employee books a conference room for an hour presentation, or a student books a study room for a few hours to host a study group. Slightly more sophisticated techniques may inquire about room occupancy, such as in the case of hotel accommodations.

It may be fairly common that people book rooms in high demand, but the actual usage of the room ends up being poor. For example, a single employee may book a conference room that seats 100 people for an event, but only 5 people attend the event. In another example, a single individual may reserve a room with the intention of using it as a personal workspace. Such instances can lead to scarce resources (e.g., rooms) during periods of high demand.

Embodiments of the present disclosure propose tracking room occupancy and usage using various sensors. For example, cameras positioned in a conference room may utilize software capable of counting the number of occupants (e.g., IBM Watson™ Visual Recognition API). Ambient room temperature may be tracked to determine how many individuals are present (e.g., a change in temperature may trend upward in correlation to the number of people in the room), smart chairs may be equipped with sensors (e.g., pressure, temperature, etc.) to determine whether the chair is occupied, door access controls may count the number of occupants that enter/exit the room, wireless network access points may track the number and type of connected devices, etc.

Room occupancy and usage information from the various sensors may be used to determine the number of people in a given room during a booked event. For example, if an educational presentation is scheduled for a conference room with a capacity for 100 people, the sensor data for that same period of time may be analyzed to determine the number of attendees. The number of attendees over the room capacity may provide a measure of room utilization, or efficiency, for the event. In embodiments, the average number of users for the duration of the booked event may allow an accounting for people that only partially attend an event.

Event efficiency may be tracked according to the booking requestor. This may allow for a historical profile for each user/requestor. In this way, users may accrue a booking efficiency data that indicates how well each user utilizes the rooms they book.

Embodiments of the present disclosure contemplate restricting the ability of users with poor booking efficiency to book rooms during periods of relatively high demand. For example, if a particular user historically uses 40% of the capacity in the rooms they book, they may be denied the ability to book a room for 50 people during a peak demand hour, or they may be given the option to book a smaller room with a capacity that more closely matches their historical booking average of 40% (e.g., a room with a capacity at or about 20 people).

In embodiments, thresholds may be set to restrict room booking privileges. For example, if a user falls below an arbitrary booking efficiency threshold (e.g., a restriction criterion), they may be denied any request for a room with a particular capacity. For example, if a workplace has set a restriction criterion at 85% for rooms with a capacity of 100+ people, a requestor with a booking efficiency of 73% may be denied a request to book a large conference room at the workplace, at least until the user increases his/her booking efficiency to 85% or more.

In embodiments, meetings/events may be associated with a priority score. The priority score may be a factor considered in booking efficiency data, or it may be used as a proxy for a user's booking coefficient. For example, if a user with a low booking efficiency is put in charge of scheduling a room for an important conference, the priority score associated with the important conference may allow the user to book the room, even though the user's own booking efficiency would normally prevent such a booking request.

Embodiments of the present disclosure may further track room usage according to event type. For example, multiple users may take turns booking a weekly status meeting. In such a circumstance, tracking booking efficiency by user may not make much sense. The room usage in this case may be better tracked using the event “weekly status meeting.” As an example, if the number of people in the weekly status meeting frequently/consistently exceeds the room capacity, then a larger alternative room may be suggested the next time any user attempts to book a room for the weekly status meeting.

In embodiments, certain periods of the day/week/month/year may consistently exhibit a peak in the demand for one or more types/sizes of room. During times of low predicted demand, it may become easier for any user, even a user with a low booking efficiency, to book a given room. However, as the predicted demand increases, one or more predicted demand thresholds may be implemented. Predicted demand thresholds may provide individual room limitations that may limit the type and/or size of room that a user can book, and the predicted demand thresholds may be considered in tandem with a user's booking efficiency.

In embodiments, booking efficiencies may be calculated in a variety of ways. For example, each user may have a booking coefficient equal to a running sum of booked rooms' occupancy during an event over the booked room's capacity. (e.g., booking coefficient=(running sum of occupancy)/(running sum of capacity)). In other embodiments, the occupancy/capacity ratio may be calculated for each booked event, and a running average of these ratios may be recorded.

In other embodiments, penalties and/or augmentations may be used to modify a user's booking efficiency data. For example, an enterprise may wish to employ a penalty for gross underutilization of conference rooms. For example, if a given event garners less than 15% efficiency, this event may impact the booking requestor's booking efficiency disproportionately downward. The aforementioned example fits the case of when a single individual reserves a large conference room solely for themselves to use as a private office. Conversely, if a given event garners greater than 90% efficiency, it may disproportionately affect the booking requestor's booking efficiency upward. In yet other embodiments, the presence/absence of peak demand may further enhance the impact of the penalty/augmentation on the user's booking efficiency.

In yet other embodiments, a decay algorithm may be employed to lessen the effect of a particular booking event on a user's booking efficiency data. For example, data related to a particular booking event may “expire” after a certain amount of time passes, a half-life formula may be applied to some or all booking events, or some combination thereof. For example, the effect of a booking event on a user's booking efficiency may “expire” after a given number of months, unless they are associated with a penalty/augmentation, in which case they may follow a half-life type formula.

In this way, users (e.g. booking requestors) may be encouraged to book the appropriate rooms for their needs, and room usage efficiency may be increased for all users, thereby increasing the resources (e.g., rooms) available during peak hours.

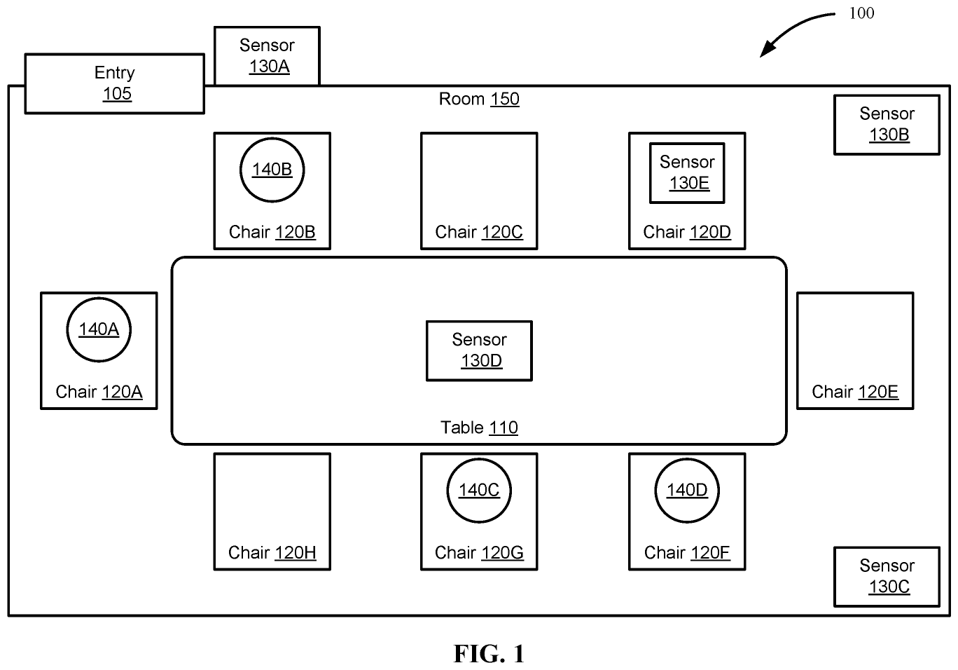

Turning now to the figures, FIG. 1 illustrates a diagram 100 of an example room 150 equipped with various sensors 130A-130E, in accordance with embodiments of the present disclosure. Room 150 may have an entryway 105 and may include sensors 130A-130E, table 110, chairs 120A-120H, and individuals 140A-14D may be present in the room 150.

Room 150 may be, for example, a conference room with a capacity of eight persons (e.g., indicated by the eight chairs 120A-120H). In embodiments, room 150′s capacity may be determined by the number of chairs present, or it may be designated by a fire marshal or other regulatory body/agency.

In embodiments, various sensors may be used as described herein to determine the occupancy for room 150 at any given point in time. For example, sensor 130A may be a door access port (e.g., a badge-reader, a keypad, etc.) capable of counting the number of individuals that enter/exit the room 150.

Sensors 130B-C may be, for example, cameras equipped with recognition software that can count and/or recognize persons, such as, for example individuals 140A-140D. Sensors 130B-C may be internet of things (e.g., IoT) devices capable of recognizing individuals 140A-140D, or capable of recognizing that number of individuals within the room (e.g, according to the number of smart phones or other personal devices in the room).

Table 110 may have sensor 130D resting upon it, or sensor 130D may be integrated into the table itself (e.g., a “smart table”). Sensor 130D may include, for example, a wireless access port or other device for connectivity to the Internet, an intranet, etc.

Chairs 120A-120H may be smart chairs equipped with one or more sensors for determining whether the chair is occupied by a person. For example, chair 120D may include sensor 130E. Sensor 130 E may include a temperature sensing device as well as a pressure sensing device to detect whether the chair 120D is bearing a load, and whether that load exhibits an expected temperature (e.g., body temperature). In this way, chair 120D may distinguish between inanimate loads (e.g., a backpack, suitcase, coat, etc.) and animate loads (e.g., an individual).

According to embodiments, the room capacity for room 150 may be eight (e.g., according to the room attribute of eight chairs 120A-120H), and the occupancy for the room at this point in time may be four (e.g., four individuals 140A-140D present). Sensors 130A-130E may monitor room 150 over the course of a booked event (e.g., a meeting, presentation, etc.) to determine, for example, that the average occupancy of the room 150 during the event was four. In this way, the event efficiency may be determined to be 50% (e.g., 4/8=0.5). This event efficiency may be recorded in a database, and it may be entered into the booking user's efficiency data. For example, if individual 140A booked the room for the event, an entry of 0.5, or 50%, may be noted in individual 140A's booking efficiency data.

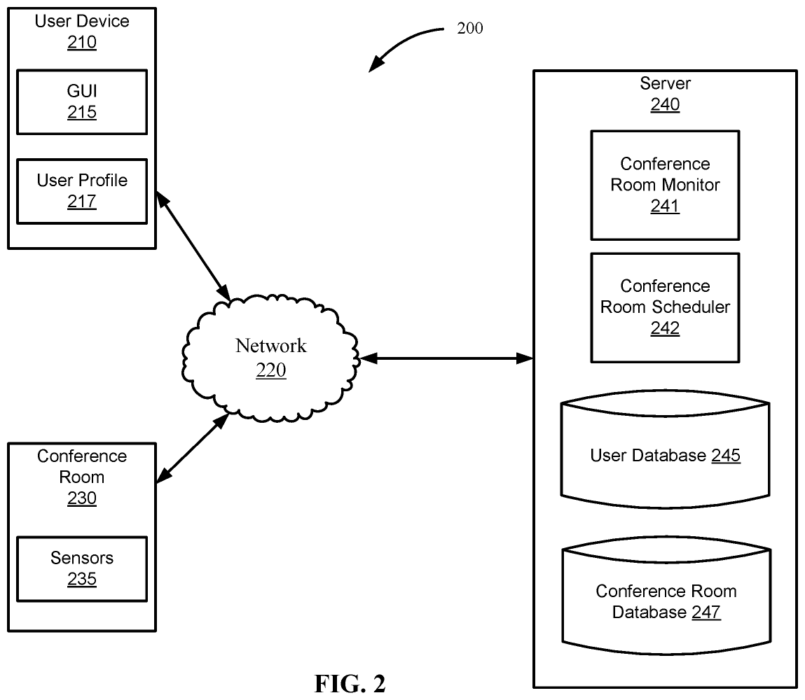

Turning now to FIG. 2, illustrated is an example networking environment 200, in accordance with embodiments of the present disclosure. Networking environment 200 may include one or more user devices (e.g., user device 210), one or more conference rooms (e.g., conference room 230), a network 220, and a server 240.

Network 220 may be any type or combination of networks. For example, network 220 may include any combination of personal area network (PAN), local area network (LAN), metropolitan area network (MAN), wide area network (WAN), wireless local area network (WLAN), storage area network (SAN), enterprise private network (EPN), or virtual private network (VPN). In some embodiments, the network 220 may refer to an IP network, a conventional coaxial-based network, etc. For example, server 240 may communicate with various client devices (e.g. tablets, laptops, smartphones, portable terminals, user device 210, conference room 230, etc.) over the Internet.

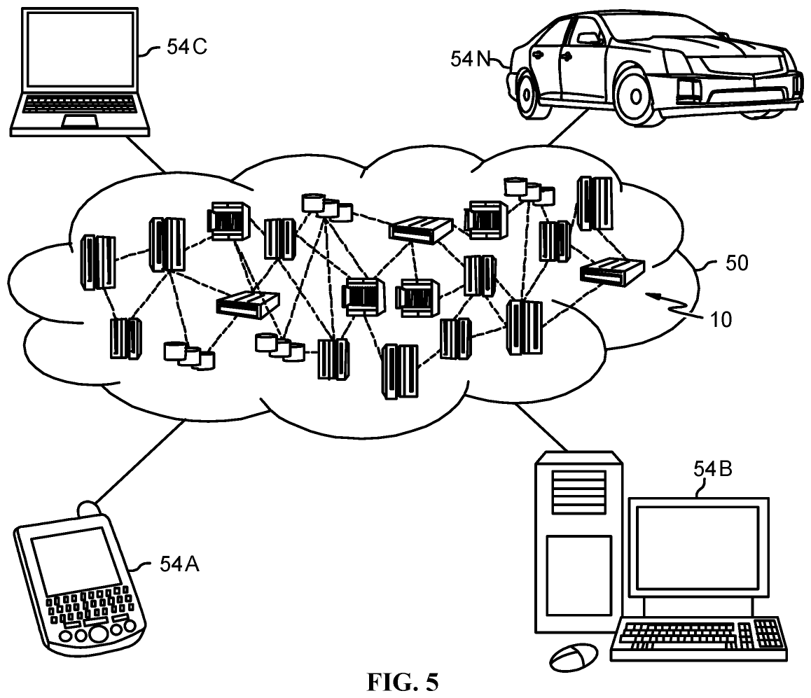

In some embodiments, the network 220 can be implemented within a cloud computing environment, or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 220. Cloud computing is discussed in greater detail in regard to FIGS. 5 & 6.

User device 210 may be a desktop, laptop, smartphone, tablet, or any other suitable computing device for a user to interact with and execute the methods/techniques described herein. In embodiments, user device 210 may include a GUI 215, and may store one or more user profiles 217. GUI 215 may include an application with interactive elements selectable by a user to generate and submit room booking requests, as well as receive confirmations, notifications, denials, alternative room suggestions, etc.

As described herein, user profile 217 may include historical and other booking efficiency data for the user/owner of user device 210. In embodiments, user profile 217 may include multiple user profiles and/or a user profile that is not associated with the user/owner of user device 210. For example, the owner/user of user device 210 may be an administrator for a room booking efficiency application with access to a set of user profiles. In embodiments, user profile 217 may include further information about the user/owner of the user device 210. In another embodiment, user profile 217 may be located on server 240.

Conference room 230 may include one or more sensors 235 for monitoring room booking efficiency and usage, as described herein. Conference room 230 may be substantially similar to Room 150 of FIG. 1, for example. Sensors 235 may include, for example, IoT devices, cameras, temperature sensors, RFID (radio frequency identification) sensors, smart chair sensors, floor plate pressure sensors, atmospheric sensors, infrared sensors, or any other type of sensor that could be used to monitor the occupancy and/or capacity of a bookable room.

In embodiments, server 240 may include a conference room monitor 241, a conference room scheduler 242, a user database 245, and a conference room database 247. Server 240 and its components may be implemented as an application running on a computing device, as a service offered via the cloud, as a web browser plugin, as a smartphone application, as a codependent application attached to a secondary application (e.g., as an “overlay” or a companion application to a partner application, such as a building map application), etc.

Conference room monitor 241 may include electrical components and/or software configured to monitor the usage and determine the occupancy and capacity of bookable rooms (such as conference room 230). In embodiments, occupancy and capacity data (e.g., historical data) may be stored in room profiles containing room attributes (e.g., capacity information, amenity information, view information, etc.) in conference room database 247. In other embodiments, occupancy and capacity data may be stored in a plurality of user profiles, such as user profile 217, and the plurality of user profiles may further be stored in user database 245.

Conference room scheduler 242 may include electrical components and/or software configured to receive booking requests from, for example, user device 210 and determine whether the booking request should be confirmed, denied, an alternate room identified and suggested, etc. Conference room scheduler 242 may operate according to the efficiency data algorithms described herein. For example, conference room scheduler 242 may calculate the running averages, booking coefficients, penalties, augmentations, etc. described herein. In embodiments, calculations may be shared, in whole or in part, with an application (e.g., the application within which GUI 215 is embedded) running on user device 210.

User database 245 may store a plurality of user profiles, such as user profile 217 and others. User database 245 may further include a plurality of event profiles, as described herein. User database 245 may include a table, list, matrix or other array, relational database, linked list, data tree, or any other configuration suitable for storing efficiency data according to user and/or event profile types. In embodiments, user database 245 may include additional information. For example, user database 245 may include metrics describing the number and frequency of room booking requests according to user, user role, event type, etc.

Conference room database 247 may store information regarding the various bookable rooms, such as conference room 230. For example, conference room database 247 may include room profiles containing room attributes, such as capacity, scheduling information, demand levels, etc. Conference room database 247 may include a table, list, matrix or other array, relational database, linked list, data tree, or any other configuration suitable for storing efficiency data according to room profile. In embodiments, the information of conference room database 247 and user database 245 may be stored in a single database.

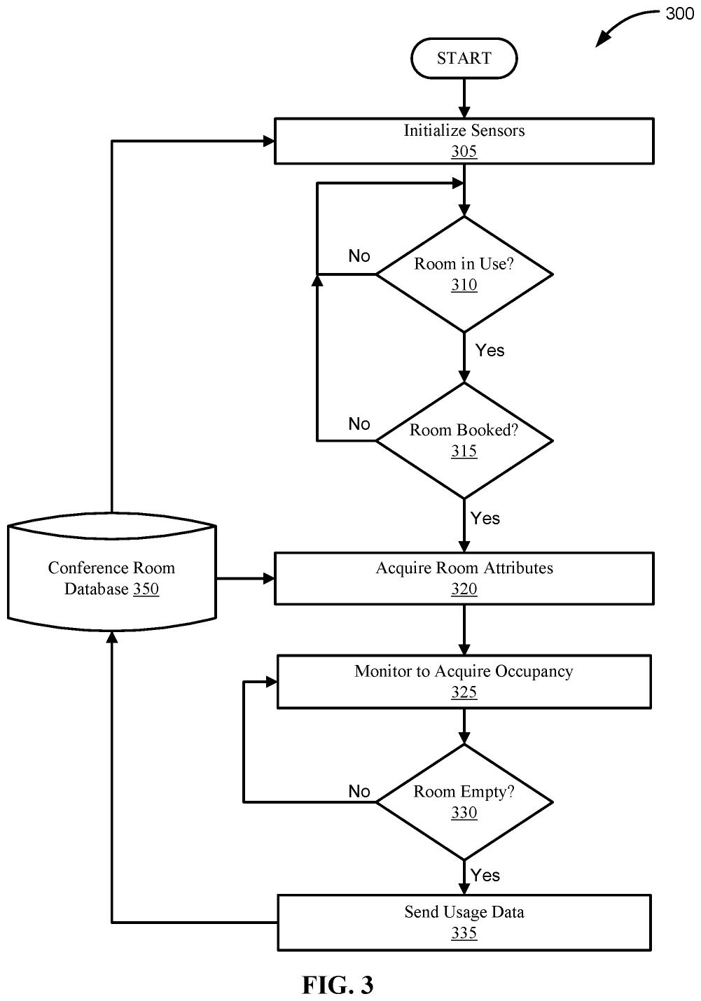

Turning now to FIG. 3, illustrated is a flowchart of a method 300 for collecting room data, in accordance with embodiments of the present disclosure. The steps of method 300 may, according to embodiments, occur in alternative orders to obtain the information contemplated herein. The method 300 may begin at 305 by initializing the sensors (e.g., 130A-130E) within a bookable room. As described herein, the sensors may include IoT devices, temperature sensors, smart chair sensors, cameras, etc. The sensors may be automatically initialized according to scheduling information received from conference room database 350. For example, conference room database 350, which may be substantially similar to conference room database 247 of FIG. 2, may include scheduling information for a bookable room which may cause the initialization at 305.

At 310, the sensors may be employed to determine if the room is actually in use. For example, the sensors may determine a room is in use if an individual is detected within the room. In embodiments, a group of individuals or specific individuals may need to be present for 310 to determine the room is in use.

If, at 310, the room is determined not to be in use, the method may loop back to check again if the room is in use. In embodiments, time interval restrictions may be introduced (e.g., the check may be performed every 30 seconds, every 2 minutes, 5 minutes, etc.), or the check may run continuously in real time until the check is passed. In embodiments, a time limit may be set at which point the method 300 may terminate (not shown) if the check is not passed. For example, if the room is not in use 15 minutes after the sensors were initialized at 305, the method 300 may terminate. In other embodiments, the room-in-use check at 310 may occur prior to the initialization of any sensors at 305.

If the room is determined to be in use at 310, it may be further determined at 315 whether the room is booked. If the room is not booked at 315 (e.g., according to the scheduling information from conference room database 350), the method 300 may return to 310. If, however, the room is booked at 315, the room attributes may be acquired. In embodiments, room attributes may be acquired from conference room database 350 at step 320, or they may be acquired in real time from sensors within the room (e.g., the number of smart chairs and IoT devices in the room may be determined). Room attributes may include, for example, room capacity (e.g., the number of seats and/or the maximum number of persons allowed in the room), a list of IoT or other amenities (e.g., coffee maker, white board, projector, refrigerator, etc.), etc.

At 325, the room is monitored to acquire the occupancy for the duration of the booking. As described herein, various sensors within the room may determine the number of individuals present (e.g., temperature increase may correlate to a number of individuals, cameras may recognize and tally persons, smart chairs may sense occupants, a wireless access point may count connected devices, an RFID badge reader may count entries/exits, a thermal/infrared sensor may recognize and tally persons, etc.) The monitoring at 325 may be performed periodically or continuously. In embodiments, one set of sensors (e.g., smart chair sensors) may monitor continuously in real time, while another set of sensors (e.g., an RFID badge reader at the door) may monitor/report only periodically (e.g., at time intervals and/or in response to another event, such as an entrance/exit of an individual).

At 330, a determination is made regarding whether the room is “empty,” (e.g. no longer in use, or when the current time equals the scheduled conference end time). If, at 330, it is determined the room is not empty, the monitoring at 325 may continue. If, however, the room is determined to be empty, or no longer in use, the data recorded during the booking (e.g., the data gathered while monitoring the event) may be sent to the conference room database 350 for storage in room profiles and/or export to a user database for use in populating/appending user profiles, as described herein. In embodiments, the booking efficiency data for the user that booked the room may be updated.

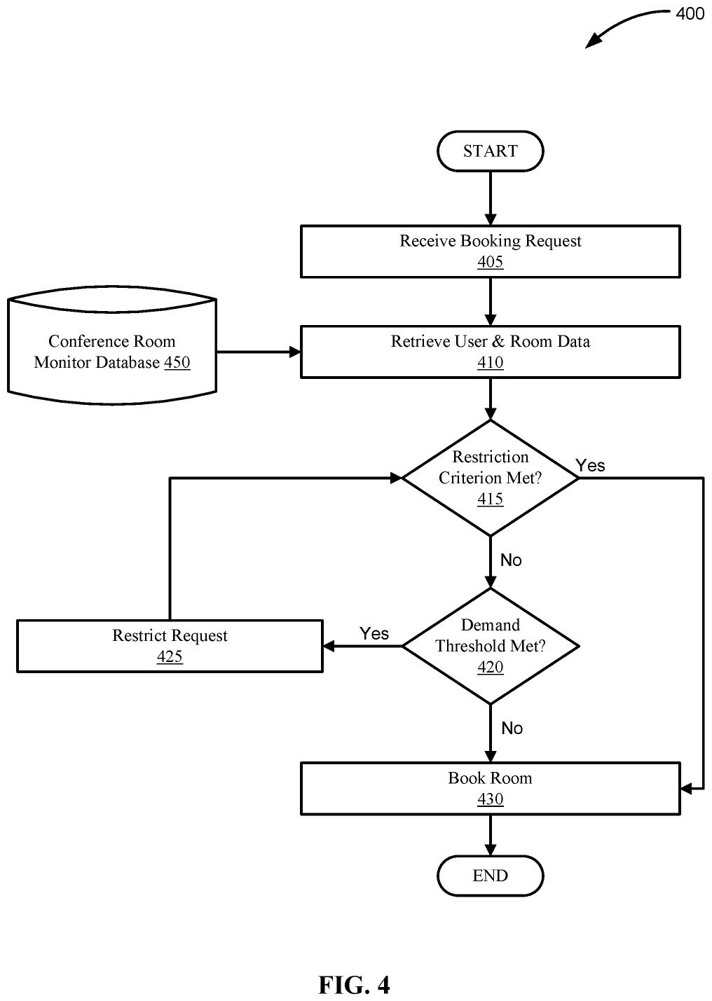

Turning now to FIG. 4, illustrated is a flowchart of a method 400 for room booking efficiency and usage allowance in accordance with embodiments of the present disclosure. At 405, a booking request may be received, as described herein. In embodiments, booking requests may include scheduling information (e.g., meeting dates/times), one or more meeting participants, and a requested conference room.

At 410, data for the user and the room may be retrieved. The retrieved data may include the information stored in a conference room monitor database 450. Conference room monitor database 450 may be substantially similar to conference room database 247 and/or user database 245 of FIG. 2. In embodiments, the retrieved data may include a user profile for the user that sent the booking request and a room profile for the requested room. In embodiments, the user profile may include the booking efficiency data for the user, and the room profile may include a set of room attributes.

At 415, it is determined, based on the booking efficiency data for the user and the set of room attributes, whether the booking request fails a restriction criterion. A restriction criterion may include, as described herein, a booking efficiency threshold against which the user's booking efficiency data may be compared. If the user's booking efficiency data passes the restriction criterion, the room may be booked at 430. If, however, the user's booking efficiency data is insufficient to pass the restriction criterion, the method 400 may proceed to 420.

At 420, it may be determined whether a predicted demand threshold for a particular room is met, as described herein. A predicted demand threshold may be employed to prevent the booking of a room during a peak hour, by a user with a poor booking coefficient. In this way, users with a history of poor booking efficiency data may be excluded from booking one or more rooms.

If, at 420, the predicted demand threshold is met, the user's booking request may be restricted at 425. This may include, in embodiments, a denial of the user's booking request. In other embodiments, 425 may include presenting the user with one or more alternate rooms to choose from. In embodiments, the alternate rooms may be chosen from a set of rooms whose attributes would have altered the restriction criterion and/or the predicted demand threshold determinations to have allowed the user's booking request to proceed.

If, however, at 420, the predicted demand threshold is not met (e.g., the predicted demand for the requested room is low), the room may be booked for the user at 430. In embodiments, demand may be determined by monitoring the number of booking requests over a set time period for the room that the user is requesting.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service deliver for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources, but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure, but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities, but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

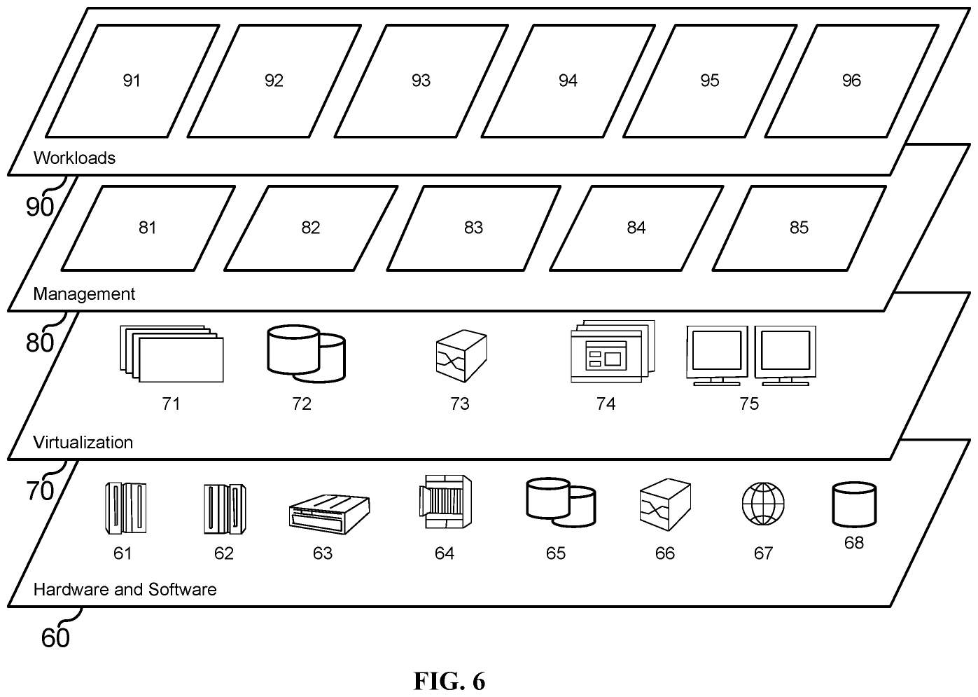

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and room booking efficiency and usage allowance 96.

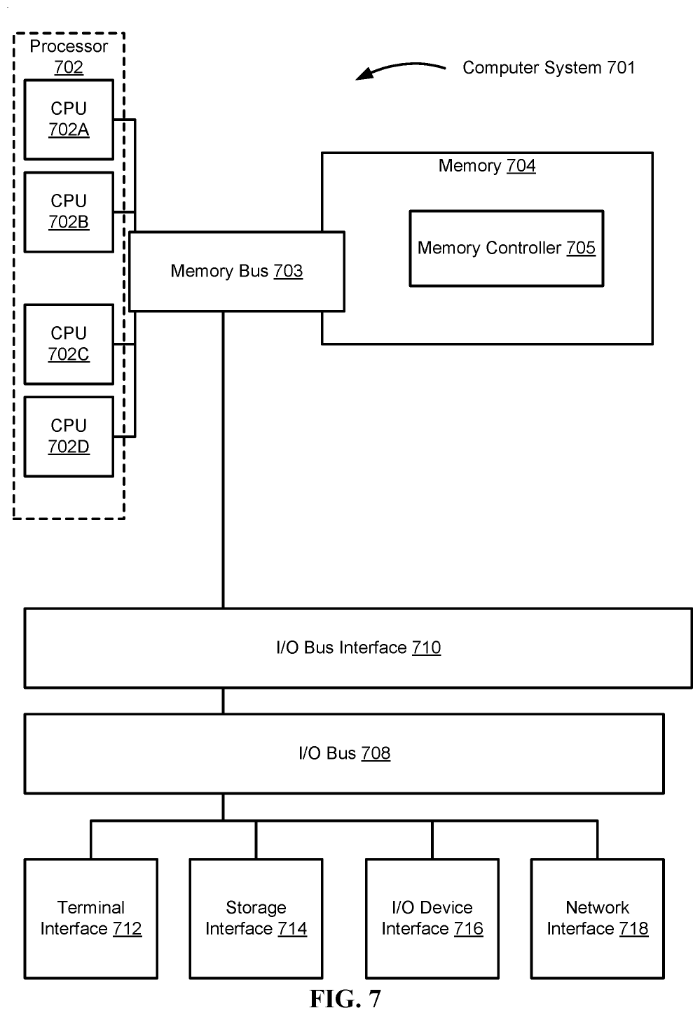

Referring now to FIG. 7, shown is a high-level block diagram of an example computer system 701 that may be configured to perform various aspects of the present disclosure, including, for example, methods 300/400, described in FIGS. 3/4, respectively. The example computer system 701 may be used in implementing one or more of the methods or modules, and any related functions or operations, described herein (e.g., using one or more processor circuits or computer processors of the computer), in accordance with embodiments of the present disclosure. In some embodiments, the major components of the computer system 701 may comprise one or more CPUs 702, a memory subsystem 704, a terminal interface 712, a storage interface 714, an I/O (Input/Output) device interface 716, and a network interface 718, all of which may be communicatively coupled, directly or indirectly, for inter-component communication via a memory bus 703, an I/O bus 708, and an I/O bus interface unit 710.

The computer system 701 may contain one or more general-purpose programmable central processing units (CPUs) 702A, 702B, 702C, and 702D, herein generically referred to as the CPU 702. In some embodiments, the computer system 701 may contain multiple processors typical of a relatively large system; however, in other embodiments the computer system 701 may alternatively be a single CPU system. Each CPU 702 may execute instructions stored in the memory subsystem 704 and may comprise one or more levels of on-board cache.

In some embodiments, the memory subsystem 704 may comprise a random-access semiconductor memory, storage device, or storage medium (either volatile or non-volatile) for storing data and programs. In some embodiments, the memory subsystem 704 may represent the entire virtual memory of the computer system 701, and may also include the virtual memory of other computer systems coupled to the computer system 701 or connected via a network. The memory subsystem 704 may be conceptually a single monolithic entity, but, in some embodiments, the memory subsystem 704 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 704 may contain elements for control and flow of memory used by the CPU 702. This may include a memory controller 705.

Although the memory bus 703 is shown in FIG. 7 as a single bus structure providing a direct communication path among the CPUs 702, the memory subsystem 704, and the I/O bus interface 710, the memory bus 703 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 710 and the I/O bus 708 are shown as single respective units, the computer system 701 may, in some embodiments, contain multiple I/O bus interface units 710, multiple I/O buses 708, or both. Further, while multiple I/O interface units are shown, which separate the I/O bus 708 from various communications paths running to the various I/O devices, in other embodiments some or all of the I/O devices may be connected directly to one or more system I/O buses.

In some embodiments, the computer system 701 may be a multi-user mainframe computer system, a single-user system, or a server computer or similar device that has little or no direct user interface, but receives requests from other computer systems (clients). Further, in some embodiments, the computer system 701 may be implemented as a desktop computer, portable computer, laptop or notebook computer, tablet computer, pocket computer, telephone, smart phone, mobile device, or any other appropriate type of electronic device.

It is noted that FIG. 7 is intended to depict the representative major components of an exemplary computer system 701. In some embodiments, however, individual components may have greater or lesser complexity than as represented in FIG. 7, components other than or in addition to those shown in FIG. 7 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for room booking, comprising:
receiving a booking request for a room;
retrieving booking efficiency data for a user associated with the booking request;
determining, based on the booking efficiency data and a set of room attributes for the room, the booking request fails a restriction criterion;
in response to failing the restriction criterion, determining a predicted demand threshold for the room is not met; and
in response to determining the predicted demand threshold is not met, booking the room for the user, according to the booking request.

2. The method of claim 1, further comprising:
receiving a second booking request for a second room;
retrieving second booking efficiency data for a second user associated with the second booking request;
determining, based on the second booking efficiency data and a second set of room attributes for the second room, the second booking request meets the restriction criterion; and
in response to the determination, booking the second room for the user, according to the booking request.

3. The method of claim 1, further comprising:
receiving a second booking request for a room;
retrieving booking efficiency data for a user associated with the second booking request;
determining, based on the booking efficiency data and a set of room attributes for the room, the booking request fails the restriction criterion;
in response to failing the restriction criterion, determining a predicted demand threshold for the room is met; and
denying the booking request for the room.

4. The method of claim 3, further comprising:
identifying an alternate room;
determining, based on the booking efficiency data and a set of room attributes for the alternate room, the booking request meets the restriction criterion; and
booking the alternate room for the user, according to the booking request.

5. The method of claim 3, further comprising:
identifying an alternate room;
determining, based on the booking efficiency data and a set of room attributes for the alternate room, the booking request fails the restriction criterion;
in response to failing the restriction criterion, determining a predicted demand threshold for the alternate room is not met; and
booking the alternate room for the user, according to the booking request.

6. The method of claim 1, wherein the booking request includes a meeting date, a meeting time, one or more meeting participants, and the desired conference room.

7. The method of claim 1, wherein the booking efficiency data for the user includes a running average of room occupancy over room capacity for a set of historical room bookings associated with the user.

8. The method of claim 7, wherein each room booking within the set of historical room bookings is weighted according to the age of the room booking.

9. The method of claim 8, wherein the booking efficiency data for the user includes a penalty for a running average of room occupancy over room capacity that does not meet a penalty threshold.

10. The method of claim 9, wherein the set of historical room bookings includes occupancy information gathered using cameras, radio-frequency identification, smart chairs, room temperature sensors, and infrared sensors.

11. A system for room booking, comprising:
a memory with program instructions included thereon; and
a processor in communication with the memory, wherein the program instructions cause the processor to:
receive a booking request for a room;
retrieve booking efficiency data for a user associated with the booking request;
determine, based on the booking efficiency data and a set of room attributes for the room, the booking request fails a restriction criterion;
in response to failing the restriction criterion, determine a predicted demand threshold for the room is not met; and
in response to determining the predicted demand threshold is not met, book the room for the user, according to the booking request.

12. The system of claim 11, wherein the program instructions further cause the processor to:
receive a second booking request for a second room;
retrieve second booking efficiency data for a second user associated with the second booking request;
determine, based on the second booking efficiency data and a second set of room attributes for the second room, the second booking request meets the restriction criterion; and
in response to the determination, book the second room for the user, according to the booking request.

13. The system of claim 11, wherein the program instructions further cause the processor to:
receive a second booking request for a room;
retrieve booking efficiency data for a user associated with the second booking request;
determine, based on the booking efficiency data and a set of room attributes for the room, the booking request fails the restriction criterion;
in response to failing the restriction criterion, determine a predicted demand threshold for the room is met; and
deny the booking request for the room.

14. The system of claim 13, wherein the program instructions further cause the processor to:
identify an alternate room;
determine, based on the booking efficiency data and a set of room attributes for the alternate room, the booking request meets the restriction criterion; and
book the alternate room for the user, according to the booking request.

15. The system of claim 13, wherein the program instructions further cause the processor to:
identify an alternate room;
determine, based on the booking efficiency data and a set of room attributes for the alternate room, the booking request fails the restriction criterion;
in response to failing the restriction criterion, determine a predicted demand threshold for the alternate room is not met; and
book the alternate room for the user, according to the booking request.

16. A computer program product for room booking, the computer program product comprising a computer readable storage medium having program instructions embodied therewith, the program instructions executable by a device to cause the device to:
receive a booking request for a room;
retrieve booking efficiency data for a user associated with the booking request;
determine, based on the booking efficiency data and a set of room attributes for the room, the booking request fails a restriction criterion;
in response to failing the restriction criterion, determine a predicted demand threshold for the room is not met; and
in response to determining the predicted demand threshold is not met, book the room for the user, according to the booking request.

17. The computer program product of claim 16, wherein the program instructions further cause the device to:
receive a second booking request for a second room;
retrieve second booking efficiency data for a second user associated with the second booking request;
determine, based on the second booking efficiency data and a second set of room attributes for the second room, the second booking request meets the restriction criterion; and
in response to the determination, book the second room for the user, according to the booking request.

18. The computer program product of claim 16, wherein the program instructions further cause the device to:
receive a second booking request for a room;
retrieve booking efficiency data for a user associated with the second booking request;
determine, based on the booking efficiency data and a set of room attributes for the room, the booking request fails the restriction criterion;
in response to failing the restriction criterion, determine a predicted demand threshold for the room is met; and
deny the booking request for the room.

19. The computer program product of claim 18, wherein the program instructions further cause the device to:
identify an alternate room;
determine, based on the booking efficiency data and a set of room attributes for the alternate room, the booking request meets the restriction criterion; and
book the alternate room for the user, according to the booking request.

20. The computer program product of claim 18, wherein the program instructions further cause the device to:
identify an alternate room;
determine, based on the booking efficiency data and a set of room attributes for the alternate room, the booking request fails the restriction criterion;
in response to failing the restriction criterion, determine a predicted demand threshold for the alternate room is not met; and
book the alternate room for the user, according to the booking request.
